(19) United States
(12) Patent Application Publication
(10) Pub. No.: US 2009/0045583 A1
(43) Pub. Date: Feb. 19, 2009

(54) Ring Sealing Between Sliding Surfaces

(76) Inventor: Vesa Ropponen, Punkalaidun (FI)

Correspondence Address: STITES & HARBISON PLLC, 1199 NORTH FAIRFAX STREET, SUITE 900, ALEXANDRIA, VA, 22314, US

(21) Appl. No.: 12/095,404

(22) PCT Filed: Dec. 4, 2006
(86) PCT No.: PCT/FI2006/000401

§ 371 Date: May 29, 2008

(30) Foreign Application Priority Data
Dec. 2, 2005 (FI) 20051240

(51) Int. Cl. F16J 15/48

(52) U.S. Cl. 277/382

(57) ABSTRACT

An o-ring seal (2) between sliding surfaces, such as a cylinder (8) and a piston (3), which is installed in an especial groove fitted for the seal, which groove is machined either in the cylinder surface or the piston surface. In order to reduce the friction between the sliding surfaces caused by the seal (2), the seal is as to its structure a broken ring, whereat it is fitted to move in the groove without pre-compression.

The invention relates to an o-ring seal between sliding surfaces, as cylinder and piston, which is installed in an especial groove fitted for the seal. The groove is worked either in the cylinder surface or the piston surface, and as to its structure the seal is broken ring. The groove is as to its breadth greater than the seal diameter and as such the seal is well known to be fitted to move in its groove to sealing position.

Previously known are o-ring seals fitted in a groove as lip seals like o-ring seals, whereby the active pressure beside the seal presses the lip against the surface of a rod, as a piston rod. Furthermore known are round seals which as to their diameter are, for instance, placed in a narrow groove so that he seal gets already by standstill pressed against all groove walls. The round seal is also installed in the groove so that it moves in the groove a little by the impact of pressure and presses against the walls of the groove meant for the seal and often against even shaped groove walls and, for instance, also against a moving surface which is to be sealed.

The disadvantage of these solutions is that the seal increases the friction between moving parts and to parts to be sealed. Especially, a pressed lip seal resist notably friction between the parts. A round seal with round cross-section has also static friction and sliding friction. The accuracy of manufacture can change, and as spare part, as to its length, a clearly a shorter o-ring seal can be the outcome, which as installed, presses the counter surface remarkably. In some cases, when the pressure in cylinder space is small or removed, the other counter part, the piston or the cylinder must be able to slide downward by its own weight. If the seal has great friction the own mass of the part is not able to move the part downwards.

The above presented structures of o-ring seals produce a remarkable sealing and a quite great sliding friction. With known o-ring seals small friction has not even been aimed at. In order to remove this lack a new of o-ring seal is developed by means of which in this regard a good result has been reached. The o-ring seal according to this invention is characterized in that in order to reduce the friction between the sliding surfaces caused by the seal, the seal is slack as to its structure, as for instance of sufficiently soft rubber quality, and it is fitted into its groove without pre-compression, whereat it is mainly fitted to move in the groove by means of pressurized flow.

The advantage of the invention is the easiness of manufacture, because the seal can be cut to length from the profile and always easily fitted into proper length. The seal drifts almost frictionless to the sealing location and out of there, so that it is very good for the purposes, in which the seal is not allowed to cause any friction. The seal is not fully tight due to its cut-off point, but on choosing its objects of use this has to be taken into consideration. In some objects of use a small leak in the seal is even allowed.

In the following the invention is disclosed with reference to the enclosed drawing, where

FIG. 1 shows the o-ring-seal in the groove of a cylinder part and an enlargement of a detail.

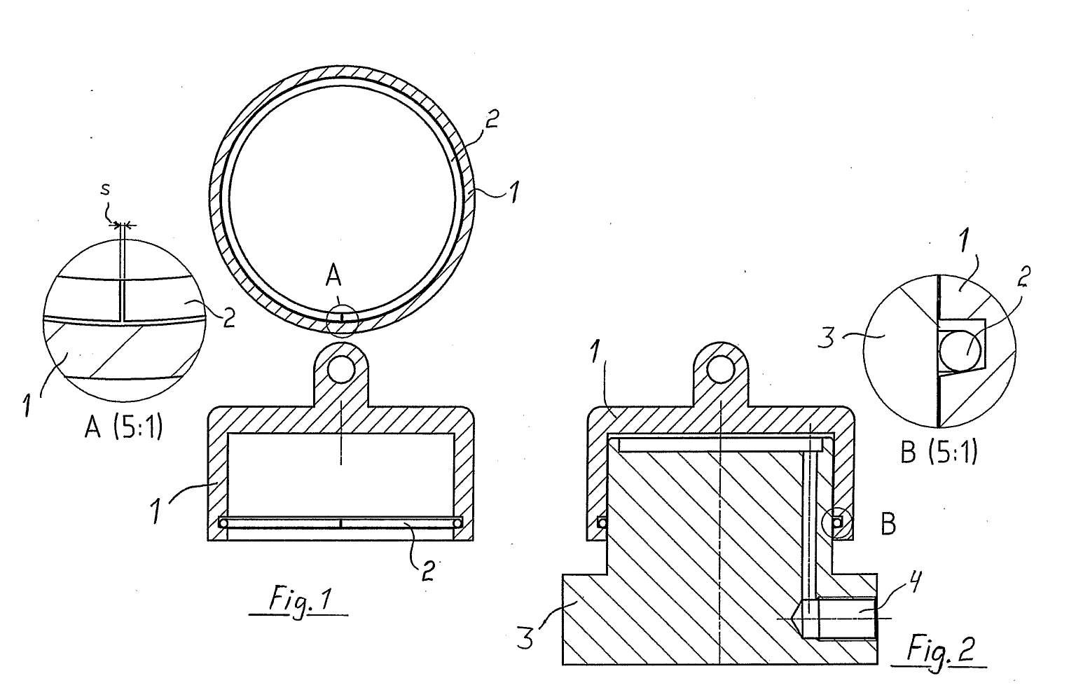

FIG. 2 shows cylinder and piston cut and an enlargement of a detail.

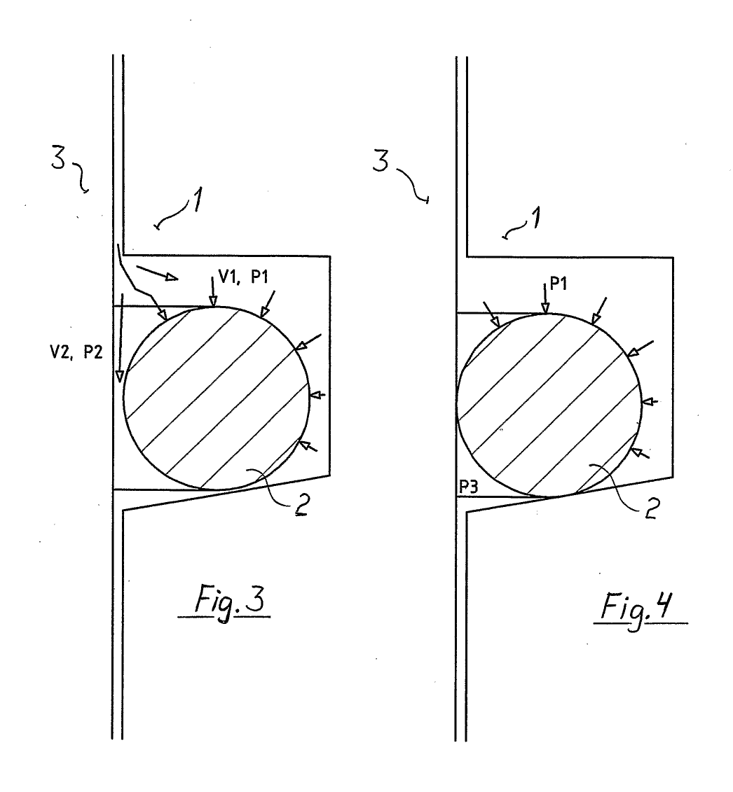

FIG. 3 shows the active forces of on a seal in standstill, when the seal starts moving into sealing position.

FIG. 4 shows the seal in sealing position under influence of pressure.

FIG. 1 shows a cylinder piece 1, on the inside surface of which there is a seal groove and in it an o-ring-seal 2. O-ring-seal 2 is cut off and in the cut-off point there is a small gap s. The gap s is as to its breadths about 10-50% of the seal cross-section diameter. Seal 2 is most suitably made by cutting off from the seal profile a proper length or cutting a piece from a little greater ring. The seal according to the invention is soft as to its quality, for instance of soft rubber, which is hardly able to be strained against any groove wall. Then the seal reacts as little as possible to the mutual motion of the groove walls An advantageous seal embodiment is of that kind that it mainly rests on the groove edges due to the weight of its own bulk.

FIG. 2 shows piston 3 inside the cylinder 1. Pressure channel 4 leads to the cylinder space. The function of o-ring seal 2 is to seal cylinder and piston with each other. The enlargement shows the seal groove, the one wall of which is inclined. Inclination is so arranged that while piston 3 is moving downward seal 2 is guided against piston 3 surface due to its inclined groove wall, and thus seals parts 1 and 3 with each other. In this case it is of advantage that also the pressure would come to have impact from the upper side of seal 2 in the figure by pressing the seal into the same corner as the motion of piston 3. The advantageous seal cross-cut shape is round.

FIG. 3 shows the enlargement of the above described case. Pressure has already come from above in the directions shown by the arrows and part 3 is starting downward. Both of these give an end result according to FIG. 4, where seal 2 is moved to sealing position. This transfer has taken place quite frictionless, since at the beginning seal 2 was not pressed against part 3. Not until in FIG. 4 it is pressed against part 3 and stays there. When pressure is removed immediately the compression of seal 2 against part 3 stops and the seal moves back almost frictionless to the position of FIG. 3.

1. An o-ring seal (2) between sliding surfaces, as a cylinder (1) and a piston (3), which is installed in an especial groove fitted for the seal, which groove is worked either in the cylinder surface or the piston surface, and the seal (2) is as to its structure a broken ring, characterized in that in order to reduce the friction between the sliding surfaces caused by seal (2), the seal is slack as to its structure, as for instance of sufficiently soft rubber quality, and it is fitted into its groove without pre-compression, whereat it is mainly fitted to move in the groove by means of pressurized flow.

2. O-ring seal (2) according to claim 1 characterized in that as to its diameter seal (2) is round.

3. O-ring seal (2) according to claim 1 characterized in that the seal is fitted to work without pre-pressure in the groove, in which groove at least one inclined wall in the sliding direction steers the seal against the adjacent sliding surface.

4. O-ring seal (2) according to claim 1 characterized in that the broken o-ring-seal (2) is as to its rest position fitted to form a gap in the braking point, when fitted in the groove.

5. O-ring seal (2) according to claim 1 characterized in that it is dimensioned to form a gap in the braking point, the breadth of which is about 50% of the seal diameter cross section.

6. O-ring seal (2) according to claim I characterized in that it is fitted to move in its groove transferred by pressure difference and by moving counter part (3).
